(19) United States
(12) Patent Application Publication
(10) Pub. No.: US 2026/0226787 A1
(43) Pub. Date: Aug. 6, 2026

(54) COMBINATION WINDOW SCREEN AND STORM WINDOW

(71) Applicant: GMW, Inc., dba, Green Mountain Window, Rutland, VT (US)

(72) Inventor: Andrew R. Keeffe, Rutland, VT (US)

(21) Appl. No.: 19/468,543

(22) Filed: Feb. 3, 2026

Related U.S. Application Data
(60) Provisional application No. 63/752,986, filed on Feb. 3, 2025.

(51) Int. Cl. E06B 3/26; E06B 5/20; E06B 9/02

(52) U.S. Cl. CPC E06B 3/2605; E06B 5/205; E06B 9/02

(57) ABSTRACT

Apparatuses and methods for improving the energy efficiency of a window in a structure while also abating noise entering the structure, and providing additional weather protection to the window. The apparatus includes a combination window screen and storm window or auxiliary window system that includes a mesh screen positioned on the exterior side of a unitary frame that may also receive shiftable and removable window panels. The frame can be made from hollow metal members for light weight and maintaining field of view through the window. Building owners can use a single apparatus to achieve both the benefits of window screens in the summer and storm windows in the winter, with potential to improve energy efficiency of a window with which the apparatus is used by as much as 50%.

### RELATED APPLICATIONS

The present application claims the benefit of U.S. Provisional Application No. 63/752,986, entitled AN IMPROVED COMBINATION STORM WINDOW AND WINDOW SCREEN, and filed Feb. 3, 2025, said application being hereby fully incorporated herein in its entirety by reference.

### TECHNICAL FIELD

The present invention relates to windows for structures, and more specifically, to storm windows and screens.

### BACKGROUND

Windows once commonly had only single thickness glass panes. These “single glass” windows, however, typically caused discomfort for building occupants due to radiant and convective heat transfer and were not energy efficient. As a result, building owners (both residential and commercial) found it useful to install storm windows or “storms” on the exterior side of their windows, typically in the winter to keep the cold out and to better retain heat inside of the home. The owners would then replace the storms in the summer with window screens that vent the building of warm or hot air that can build up inside.

Early exterior window coverings, like storms and screens, were made of wood. This design was useful to maintain structural integrity. However, while robust, the use of wood made these coverings particularly heavy and unwieldy. Wood-frame coverings also need routine maintenance, in the form of painting, to ensure that they last from year-to-year.

Products exist that combine functions of storms and screens into a single, wood frame. Building owners have not widely adopted these storm/screen combination coverings. Often, these coverings are even heavier and more difficult to handle than conventional storms (and screens) because they simply add more components to the already thick, heavy wood frame of the storms. Use of wood storm/screen combinations has also been limited, particularly as an aftermarket product, because not all window designs have space to receive a thick wood frame. This is especially true of more modern window designs made of metal, vinyl, fiberglass, and the like.

Aluminum and other modern materials make it much easier to manufacture storm/screen combinations. Manufacturers can use these materials to create coverings that are lighter and require less maintenance than wood-based designs. The metal-based coverings also have a lower profile and wider field-of-view that enables them to be installed on virtually all types of windows, whether older (wood frame) or more modern (metal, vinyl, fiberglass, and the like). As a result, there remains only a small market for storms and storm/screen combinations made of wood, mainly for applications that have older wood-frame windows, or for customers that prefer the wood-frame look over metal and do not mind the necessary maintenance that wood-frame storms and screens require on a regular basis.

Like previous wood-frame products, aluminum storm/screen combination coverings install on the exterior side of existing windows. These coverings usually have an aluminum frame that fastens with screws onto the exterior of the existing window. Glass panels in aluminum “surrounds” insert into the aluminum frame on the outside. The aluminum frame also receives a separate screen with aluminum “surrounds” on the inside. Often, in double hung windows, this screen only covers half of the window opening and, in use, building owners slide the screen up and down within the aluminum frame.

While superior to wood-frame designs, these newer aluminum-frame combination coverings are not without their drawbacks. The “half-screen” look, for example, is thought to be unsightly because the screen shades only half of the opening of the primary window. This feature obscures the view and makes it obvious that the building includes storms over its primary windows. Additionally, the glass panels on the exterior side of the aluminum-frame combination coverings often create reflections that detract from the overall look of the building.

Also, typical aluminum-frame combination coverings are usually semi-permanently fastened to the primary windows (e.g. with screws) and are not designed to be removed. Removal may cause permanent damage to the primary window and covering.

Typical aluminum-frame combination coverings are constructed from four primary components: an open frame, a top glass panel with aluminum surrounds, a bottom glass panel with aluminum surrounds and a mesh screen with aluminum surround. The use of multiple independently fabricated components increases manufacturing complexity and cost, and results in a thicker, than optimal, less aesthetically, pleasing assembly.

As a result, building owners do not view aluminum-frame combination coverings favorably in the marketplace. They are more likely to replace their primary windows with new windows, rather than add storm/screen combination coverings. This is expensive for the building owner, and wasteful and detrimental to the environment because the original, replaced windows almost always end up in a landfill.

Hence, there is a need in the industry for a storm/screen combination covering that addresses these drawbacks.

### SUMMARY OF THE DISCLOSURE

The present application addresses the drawbacks of prior devices by providing a combination window screen and storm window and auxiliary window system including a screen mesh positioned on the exterior side of a frame that may also receive a glass panel (or panels). Embodiments of the inventions combine properties of a storm/screen combination covering (like energy efficiency, noise abatement or reduction, and weather protection) with the convenience, appearance, and narrow profile of a metal window screen. In addition to eliminating the unsightly “half-screen” look and reducing glare and reflections, these features may enable building owners to use a single device to achieve both the benefits of window screens in the summer and storms in the winter, with potential to improve energy efficiency by as much as 50%. Recent developments in high performance coatings and glazing materials (e. g low emissivity (“Low-E”), UV inhibiting, etc.), which can now be used monolithically, permit the embodiments to help reduce energy consumption, thus playing a role to reduce pollution emitted from non-renewable sources of energy.

According to an embodiment, a combination window screen and storm window includes a frame having a top rail, a bottom rail, and a pair of opposing side rails defining an opening. The frame has an exterior side presenting an exterior face and an interior side presenting an interior face. The frame defines a track in the opening adjacent the interior face, and a screen is disposed on the exterior side of the frame. An upper window panel is disposed in an upper portion of the opening between the exterior side of the frame and the interior side of the frame, and a lower window panel is disposed in the track and is slidably shiftable in the track between a lowered position in which the lower window panel is disposed in a lower portion of the opening, and a raised position in which the lower window panel is disposed in the upper portion of the opening adjacent the upper window panel. The frame is adapted to mount on the exterior side of a window with the interior side of the frame facing the window.

In a further embodiment, the exterior face of the frame defines a groove extending around the opening, and the screen presents an outer periphery. A spline is received in the groove to attach the screen to the frame. The lower window panel can further include a sliding latch selectively operable to latch the lower window panel in the lowered position or the raised position. The sliding latch may be selectively operable to latch the lower window panel in at least one intermediate position between the lowered position and the raised position.

In further embodiments, the lower window panel or the upper window panel or both may be selectively removable from the frame. The top rail, bottom rail, and opposing side rails of the frame may be hollow, and may be made from aluminum, fiberglass, steel, or high strength rigid plastic.

In still further embodiments, the top rail, bottom rail, and opposing side rails of the frame each have an outwardly facing edge surface, the outwardly facing edge surface defining a slot with a T-shaped cross-section. A plurality of weatherstripping members each having a T-shaped cross-section may be provided, each one of the plurality of weatherstripping members received in a separate one of the slots. The frame may define a thickness dimension extending between the exterior face and the interior face, the combination window screen and storm window further including an adapter having a T-slot engaging projection adapted to be received in the slot, the adapter presenting a thickness dimension less than the thickness dimension of the frame.

In another embodiment, an auxiliary window system adapted to mount on an exterior side of a window in a structure includes a hollow metal frame having a top rail, a bottom rail, and a pair of opposing side rails framing an opening, the frame presenting an exterior side, an interior side, and an outwardly facing edge surface, a mesh screen covering the opening on the exterior side. A first window panel having a transparent portion is disposed in the opening in the frame between the interior side and the exterior side. The window panel is selectively shiftable between a lowered position in which the window panel closes the opening to block air from passing through the mesh screen and a raised position in which the window panel is shifted to enable air passage through a portion of the mesh screen.

In an embodiment, the first window panel may be selectively removable from the frame. In a further embodiment, the first window panel can have a latch enabling the first window panel to be positioned at an intermediate position between the lowered position and the raised position, the intermediate position enabling air passage through a portion of the mesh screen.

In another embodiment, a second window panel having a transparent portion is disposed in the opening in the frame between the interior side and the exterior side. The first window panel is disposed in a first plane inside the opening and the second window panel is disposed in a second plane parallel with the first plane.

The second window panel may be fixed in position in an upper portion of the opening, and the first window panel disposed in a lower portion of the opening when the first window panel is in the lowered position. The mesh screen can present an outer periphery and can have a spline along the outer periphery, the frame having an outer face defining a groove on the exterior side, and the spline being received in the groove to attach the screen to the frame.

In embodiments, the outwardly facing edge surface may define a slot having a T-shaped cross-section. The system can further include a plurality of weatherstripping members, the weatherstripping members having a T-shaped cross-section conforming to the T-shape of the slot, the weatherstripping members being received in the slot.

In embodiments, the frame defines a thickness dimension extending between the exterior face and the interior face, the system further including an adapter having a T-slot engaging projection adapted to be received in the slot, the adapter presenting a thickness dimension less than the thickness dimension of the frame.

In embodiments, the frame defines a thickness dimension extending between the exterior face and the interior face, the thickness dimension being within a range from ½ inch to ¾ inch inclusive. In an embodiment, the thickness dimension is ¾ inch.

In embodiments, the frame defines a track, the first window panel being slidable in the track.

In a further embodiment, a method of improving the energy efficiency of a window in a structure while enabling natural ventilation of the structure through the window includes providing a combination window screen and storm window including a frame having a top rail, a bottom rail, and pair of opposing side rails framing an opening, the frame presenting an exterior side, an interior side, and a outwardly facing edge surface, the top rail, the bottom rail, and each one of the pair of opposing side rails being a hollow metal section, a mesh screen on the frame covering the opening on the exterior side, and a first window panel having a transparent portion in the opening in the frame between the interior side and the exterior side, the window panel being selectively shiftable between a lowered position in which the window panel closes the opening to block air from passing through the mesh screen and a raised position in which the window panel is shifted to enable air passage through a portion of the mesh screen, and affixing the combination window screen and storm window on an exterior side of the window.

In further embodiments, an auxiliary window system adapted to mount on an exterior side of a window in a structure includes a frame assembly presenting an exterior side, an interior side, and an outwardly facing edge surface, the frame assembly having a hollow top rail, a hollow bottom rail, and a pair of opposing hollow side rails together framing an opening, and a mesh screen entirely covering the opening; an upper window panel having a transparent portion, the upper window panel disposed in an upper portion of the opening between the interior side and exterior side of the frame assembly; and a lower window panel having a transparent portion, the lower window panel disposed in the opening in the frame between the interior side and the exterior side, the window panel being selectively shiftable between a lowered position in which the window panel closes a lower portion of the opening to block air from passing through the mesh screen and a raised position in which the lower window panel is shifted to enable air passage through the mesh screen.

Advantages, benefits, and features of embodiments of the invention may include, but are not limited to, some or all of the following:
A full-length screen mesh attached to a frame so as to provide room for interior mounted glass panel(s), while reducing the required frame thickness by roughly one-third when compared to a traditional wood storm or aluminum storm/screen combination window. This feature allows the window covering to install on a wider variety of window types, and helps conceal the panels and reflective glass behind the mesh screen when viewed from the exterior.
Mechanisms to easily install and remove the combination window screen and storm window. This feature enables building owners to remove the combination window screen and storm window seasonally, if desired, or for maintenance like cleaning, and does not require separate and more permanent fasteners (e.g. screws) that may cause long term damage to the primary window frame.
Weather-stripping around perimeter edge of the combination window screen and storm window. This feature facilitates installation and removal of the combination window screen and storm window because it creates a weather seal between the primary window frame and the combination window screen and storm window, without the need to fasten (e.g., screw) the frame to the primary window frame to make the weather seal. The embodiments may leverage different size weatherstrips to adapt the combination window screen and storm window to different types of primary window frames, for example, to cover large gaps or out of square primary window frames.
An adaptor that alters the edge thickness of the frame. This feature provides a custom fit, resulting in increased versatility and adaptability to accommodate a wide range of installations.
Reduced frame thickness compared to traditional wood storm or aluminum storm/screen combination windows. Wood storms and storm/glass combinations need to be about 1″ thick to be structurally sound. The proposed design of this window covering is structurally sound at about ½″ to ¾″ thick. This feature ensures compatibility with both modern and older window frames, thereby facilitating its use as a replacement for conventional window screens.
Improved sightlines and field of view compared to traditional wood storms or aluminum storm/screen combination windows. Wood storms and combinations impede view and reduce the amount of sunlight coming through the window because of the wider frame dimensional requirements to keep them structurally sound.
The screen mesh is retained within an exterior groove in the frame using a spline, enabling the mesh to be included and secured without adding to the overall thickness of the assembly. This configuration supports a thin-profile frame, enhances installation: flexibility, and permits straightforward replacement of the mesh with commonly available fiberglass, aluminum, or steel mesh material if it becomes damaged.
Fewer main components are used when compared to a typical aluminum framed combination covering. The typical aluminum framed combination covering uses four main components: an open frame; a top glass panel with aluminum surrounds; a bottom glass panel with aluminum surrounds and a mesh screen with aluminum surround (three inserts added to a frame). Embodiments of the invention use only three main components: a frame with attached screen mesh; a top glass panel with aluminum surrounds, and a bottom glass panel with aluminum surrounds (two inserts added to a frame). This design reduces manufacturing labor, material usage, and shipping costs due to its lighter weight and reduced overall thickness. It also improves the visual appearance of the unit and supports a slimmer, more refined assembly profile.
A more portable screen/glass combination covering. The narrow, hollow frame of the proposed design weighs a fraction of the weight of traditional wood storm or storm/screen combination windows. The weight of wood units make them generally difficult to install and remove, often requiring multiple persons.

The summary above is not intended to describe each illustrated embodiment or every implementation of the present disclosure. The figures and the detailed description that follow more particularly exemplify these embodiments.

### BRIEF DESCRIPTION OF THE DRAWINGS

Subject matter hereof may be more completely understood in consideration of the following detailed description of various embodiments in connection with the accompanying figures, in which:

FIG. 1 is an exploded view of a combination window screen and storm window according to an embodiment of the invention with a window;

FIG. 2 is an exterior elevation view of the combination window screen and storm window of FIG. 1;

FIG. 3 is an interior elevation view of the combination window screen and storm window of FIG. 1;

FIG. 4 is a cross-section view of a first embodiment of the invention taken at section 4-4 of FIG. 3;

FIG. 5 is a cross-section view of the first embodiment of the invention taken at section 5-of FIG. 3;

FIG. 6 is a detail view of a portion of FIG. 4;

FIG. 7 is a detail view of a portion of FIG. 5;

FIG. 8 is a detail view of a portion of FIG. 4;

FIG. 9 is a detail view of a portion of FIG. 4;

FIG. 10 is a cross-section view depicting an adapter enabling the combination window screen and storm window to be installed in an existing, narrower screen mount;

FIG. 11 is a cross-section view of a second embodiment of the invention taken at section 11-11 of FIG. 3;

FIG. 12 is a cross-section view of the second embodiment of the invention taken at section 12-12 of FIG. 3;

FIG. 13 is a detail view of a portion of FIG. 11;

FIG. 14 is a detail view of a portion of FIG. 12;

FIG. 15 is a detail view of a portion of FIG. 11;

FIG. 16 is a detail view of a portion of FIG. 11;

FIG. 17 is a cross-section of a window with the combination window screen and storm window installed;

FIG. 18A is the detail view of FIG. 14 with an exploded view of an alternate embodiment of an adaptor enabling the combination window screen and storm window to be installed in an existing, narrower screen mount;

FIG. 18B is a view of a portion of FIG. 18A showing the adaptor fitted to the combination window screen and storm window; and

FIG. 19 is a cross-section view showing the adaptor of FIGS. 18A and 18B in use with a vinyl window profile.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

This detailed description is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “coupled,” “connecting”, “attached”, “attaching”, “join” and “joining” are used interchangeably and refer to one structure or surface being secured or linked to another structure or surface or integrally fabricated in one piece, unless expressively described otherwise.

Features of the embodiments depicted in the drawings will now be described. These features provide an assembly or system that combines screen mesh and removeable glass panels in a frame that enables it to replace separate window screens and storm windows. The frame has a profile that enables it to fit into the same location as a conventional (aluminum) window screen or existing recess in the window frame. Embodiments of the invention fix window screen mesh directly to a structural frame in a way that does not increase the overall thickness of the device. To keep the look of a conventional (aluminum) window screen, the screen mesh is positioned on the exterior side, covering the entire window opening. This feature helps conceal the glass panels because it eliminates glass reflection and glare.

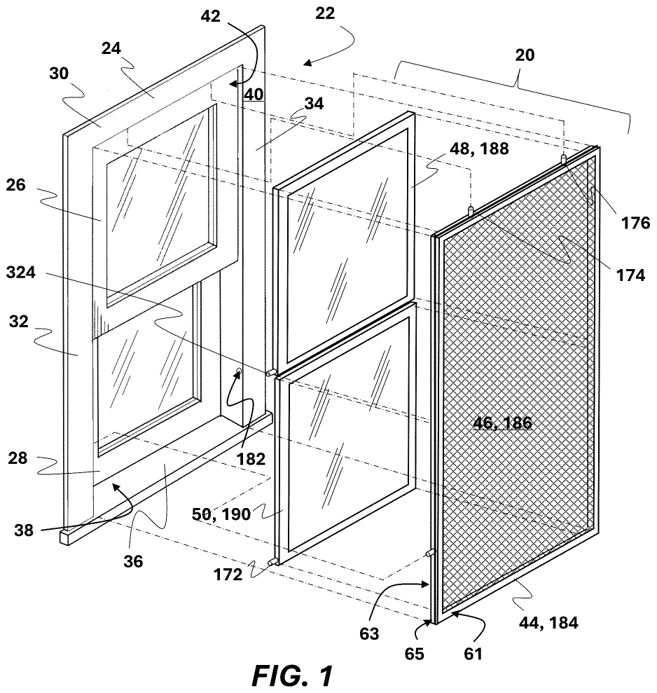

FIG. 1 depicts, in an exploded view, a combination window screen and storm window 20 according to embodiments of the invention with a typical double-hung window 22 as is common in residential construction. Combination window screen and storm window 20 may be alternatively referred to as an auxiliary window system. Window 22 generally includes frame 24, upper sash 26, and lower sash 28. Frame 24 generally includes header 30, opposing jambs 32, 34, and sill 36, defining opening 38. Upper sash 26 is often fixed in place, while lower sash 28 is vertically shiftable in frame 24 to enable ventilation to the structure in which window 22 is installed. Notably, upper sash 26 is recessed slightly from exterior face 40, forming a recess 42 that can receive combination window screen and storm window 20.

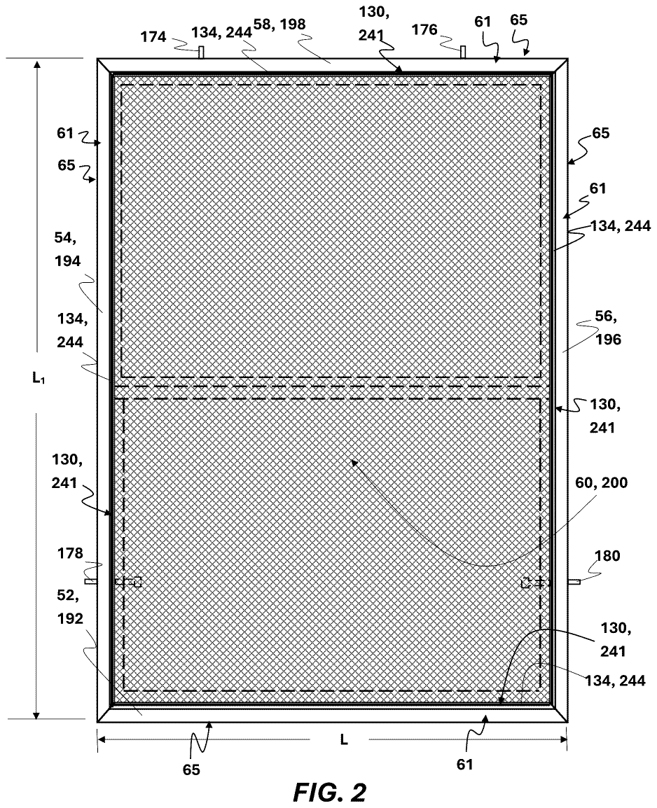

A first embodiment of combination window screen and storm window 20 is depicted in FIGS. 2-9, and generally includes frame 44, screen mesh 46, upper window panel 48, and lower window panel 50. Frame 44 generally includes bottom rail 52, opposing side rails 54, 56, and top rail 58, defining an opening 60. Frame 44 presents exterior side 61, interior side 63, and outwardly facing edge surface 65.

Bottom rail 52, depicted in cross-section in FIG. 6, may be made from thin lightweight metal such as aluminum, and generally includes hollow outer portion 62 and hollow inner portion 64. Outer portion 62 presents bottom surface 66, in which slot 68 is defined. As depicted in FIG. 6, slot 68 is T-shaped in cross-section and extends along the entire length L of bottom rail 52. Outer face 70 defines outwardly facing recess 72. Inner portion 64 encloses hollow recess 74 having open upper end 76. Weatherstripping 78 is provided on both inner faces 80, 82, facing into recess 74. It will be appreciated that bottom rail 52 may be extruded in a single integral piece including outer portion 62 and inner portion 64, or outer portion 62 and inner portion 64 may be formed separately and joined together using any suitable process so as to be permanently coupled together. As mentioned, bottom rail 52 may be made from aluminum, but may also be made from any other suitable material such as fiberglass, steel, or high strength rigid plastic.

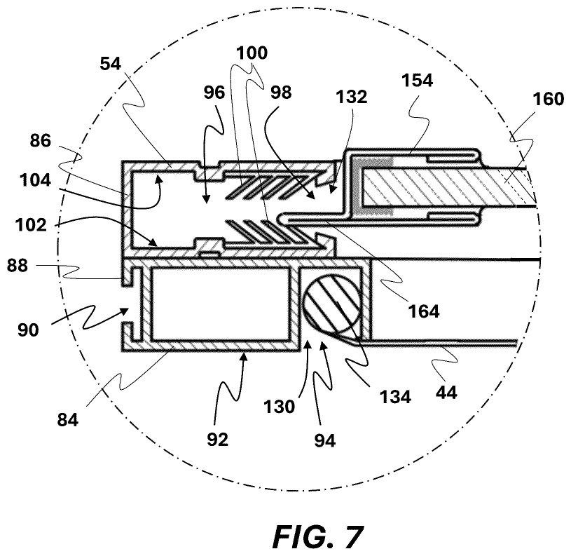

Side rails 54, 56, may also be made from thin lightweight metal such as aluminum. A cross-section of side rail 54 (side rail 56 is the mirror image) is depicted in FIG. 7, and generally includes hollow outer portion 84 and hollow inner portion 86. Outer portion 84 presents side surface 88, in which slot 90 is defined. As depicted in FIG. 7, slot 90 is T-shaped in cross-section and extends along the entire length L₁ of each side rail 54, 56. Outer face 92 defines outwardly facing recess 94. Inner portion 86 encloses hollow recess 96 having open side 98. Weatherstripping 100 is provided on both inner faces 102, 104, facing into recess 96. Again, it will be appreciated that side rails 54, 56, may be extruded in a single integral piece including outer portion 84 and inner portion 86, or outer portion 84 and inner portion 86 may be formed separately and joined together using any suitable process so as to be permanently coupled together. As mentioned, side rails 54, 56, may be made from aluminum, but may also be made from any other suitable material such as steel, or high strength rigid plastic.

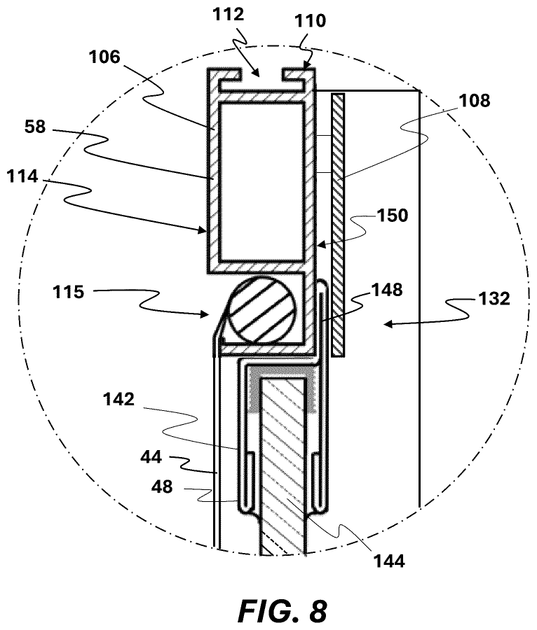

Top rail 58 is depicted in cross section in FIG. 8, and generally includes body portion 106 and retaining clips 108. Body portion 106 presents upper surface 110, in which slot 112 is defined. As depicted in FIG. 8, slot 112 is T-shaped in cross-section and extends along the entire length of top rail 58, which is the identical length as bottom rail 52. Outer face 114 defines outwardly facing recess 115. Body portion 106 may be made from aluminum, but may also be made from any other suitable material such as steel, or high strength rigid plastic.

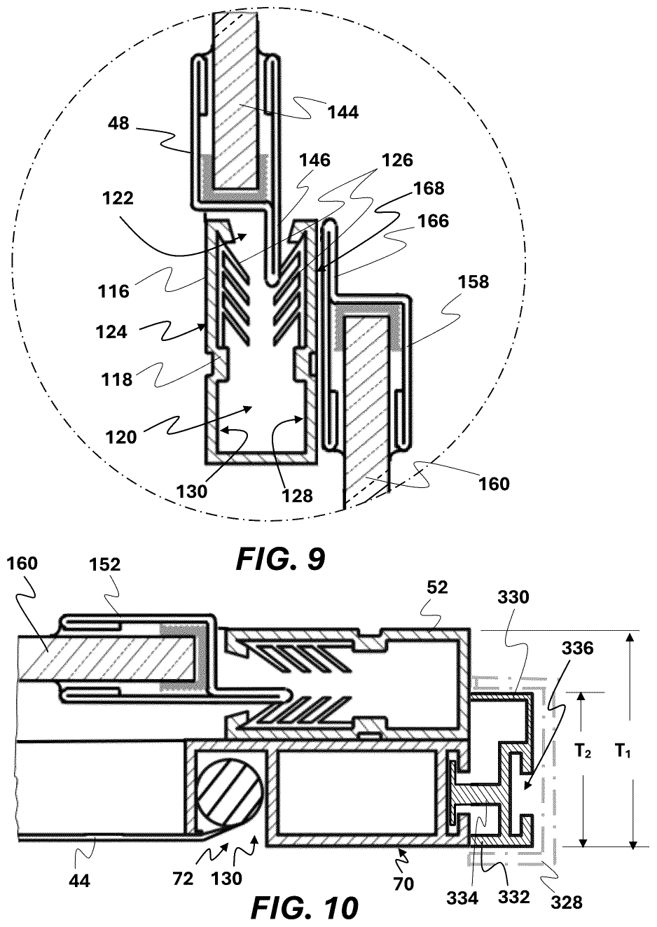

FIG. 9 depicts a cross-section of optional center rail 116. Center rail 116 extends between side rails 54, 56, and generally includes body portion 118 enclosing hollow recess 120 having open top 122 and presenting outer face 124. Weatherstripping 126 is provided on both inner faces 128, 130, facing into recess 120. As with bottom rail 52, side rails 54, 56, and top rail 58, center rail 116 may be made from aluminum, but may also be made from any other suitable material such as steel, or high strength rigid plastic.

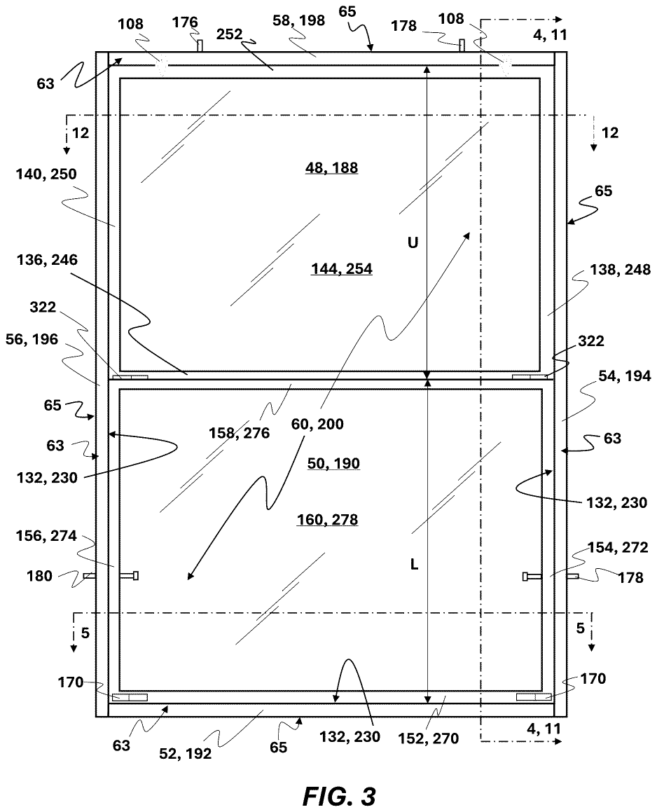

Bottom rail 52, opposing side rails 54, 56, top rail 58, and optionally center rail 116, may be joined together with outer faces 70, 92, 114, and 124 facing the same direction to form frame 44. Recesses 72, 94, and 115 register with each other so as to define groove 130 surrounding opening 60 as depicted in FIG. 2. Open upper end 76 of bottom rail 52 and open sides 98 of side rails 54, 56, are aligned so as to form a track 132 extending around opening 60 on the interior side as depicted in FIG. 3.

As depicted, slots 68, 90, 112, may receive weatherstripping 133 having a T-shaped cross-section conforming to the T-shaped cross-section of the slots. Alternatively, slots 68, 90, 112, may receive other components useful to adapt frame 44 to fit with existing window screen mounts as will be further described hereinbelow.

Screen 46 may made from commonly available window insect screen material such as fiberglass, aluminum or plastic. Spline 134 is received in groove 130 as depicted in FIGS. 2, 6, and 7 to secure screen 46 in place so that screen 46 is stretched to cover entire opening 60.

Upper window panel 48 generally includes bottom rail 136, opposing side rails 138, 140, and top rail 142, receiving glass panel 144. Without limitation, glass panel 144 may be single thickness glass, laminated glass, thin-insulated glass, safety glass, vacuum-sealed insulated glass, all with or without a low-e or other coating, solar photovoltaic glass or panel, or any other type of thin transparent, translucent, or opaque material. Bottom rail 136 and top rail 142 each have a projecting flange 146, 148, respectively. Upper window panel 48 is held in upper portion U of opening 60 as depicted in FIG. 3. Projecting flange 148 abuts inner face 150 of body portion 106 of top frame rail 58, and is held in place with retaining clips 108. Bottom rail 136 rests on center rail 116, with projecting flange 146 extending into open top 122 as depicted in FIG. 9. Side rails 138, 140, abut side rails 54, 56, of frame 44, respectively with weatherstripping (not depicted) sandwiched in between.

Lower window panel 50 generally includes bottom rail 152, opposing side rails 154, 156, and top rail 158, receiving glass panel 160. Again, glass panel 160 may be single thickness glass, laminated glass, thin-insulated glass, safety glass, vacuum-sealed insulated glass, all with or without a low-e or other coating, solar photovoltaic glass or panel, or any other type of thin transparent, translucent, or opaque material. Bottom rail 152 has projecting flange 162, each of side rails 154, 156, has projecting flange 164, and top rail has projecting flange 166.

Lower window panel 50 is slidably received in track 132 of frame 44, with projecting flanges 164 extending into recesses 96. Lower window panel can be disposed in a lowered position as depicted in FIG. 3, in which projecting flange 162 is received in recess 74, and projecting flange 166 abuts inner surface 168 of center rail 116, thereby fully closing lower portion L of opening 60. Bottom rail 152 may have sliding latches 170 which can selectively withdraw pins 172 (which may be spring-loaded), which engage with holes (not depicted) in frame 44. Lower window panel 50 can be slid upward in track 132 from the lowered position depicted, to a fully raised “self storing” position in which lower window panel 50 is positioned in upper portion U of opening 60 parallel with upper window panel 48. Sliding latches 170 can be used to extend pins 172 to engage holes (not depicted) in track 132 to hold window panel 50 in this position when it is desired to fully open lower portion L of opening 60 for ventilation. It will be appreciated that additional holes (not depicted) may be provided in track 132 to enable lower window panel 50 to be positioned at one or more intermediate points between the lowered position and the fully raised position and held in place with pins 172.

Moreover, lower window panel 50 may be removed from track 132 by fully retracting pins 172 and lifting lower window panel 50 out of frame 44. In addition, if it is desired to use the entire opening 60 for ventilation, upper window panel 48 can also be removed from frame 44 by loosening the fasteners (not depicted) attaching retaining clips 108 to frame 44, and pivoting retaining clips 108 to enable the top edge of upper window panel 48 to be tilted inward. Once tilted, upper window panel 48 can likewise be lifted out of frame 44.

As depicted in FIGS. 1-3, frame 44 has projecting pins 174, 176, 178, 180, to enable combination window screen and storm window 20 to be secured to the exterior side of a window 22. Pins 174, 176, may be fixed, while pins 178, 180, are axially slidable so that a user can extend and retract them as desired. Pins 174, 176, 178, 180, can engage in pre-drilled holes 182 in window frame 24 to secure combination window screen and storm window 20 in place. During installation, pins 174, 176, can be first advanced into pre-drilled holes (not depicted) in header 30, then pins 178, 180, can be retracted while the bottom edge of combination window screen and storm window 20 is swung in toward window 22. Once combination window screen and storm window 20 is properly positioned, pins 178, 180, can be extended into pre-drilled holes 182 to secure combination window screen and storm window 20 in place. Removal can be accomplished by reversing this procedure.

Another embodiment is depicted in FIGS. 1-3 and 11-17. In the depicted embodiment, combination window screen and storm window 20 generally includes frame 184, screen 186, upper window panel 188, and lower window panel 190. Frame 184 generally includes bottom rail 192, opposing side rails 194, 196, and top rail 198, defining an opening 200.

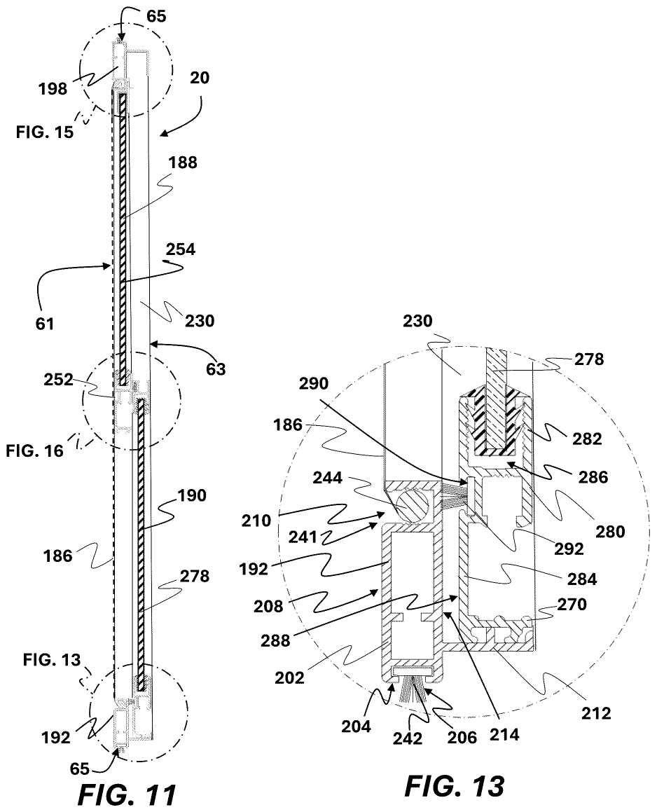

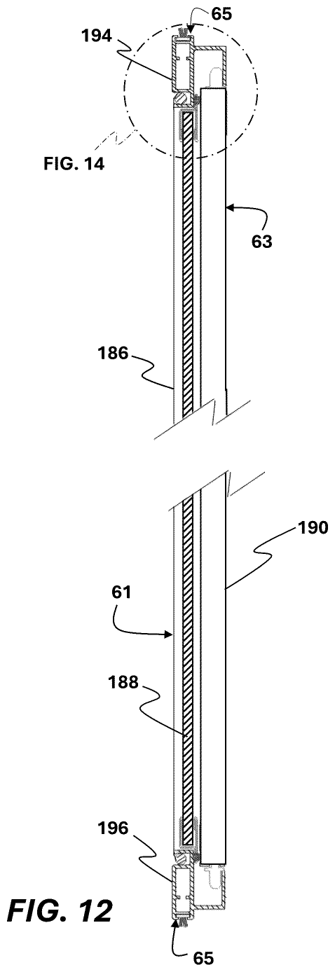

FIG. 11 depicts a cross-section taken at section 11-11 of FIG. 3, and FIG. 12 depicts a cross-section taken at section 12-12 of FIG. 3. Bottom rail 192, depicted in cross-section in FIG. 13, may be made from thin lightweight metal such as aluminum, and generally includes body 202, presenting bottom surface 204, in which slot 206 is defined. As depicted in FIG. 13, slot 206 is T-shaped in cross-section and extends along the entire length L of bottom rail 192. Outer face 208 defines outwardly facing recess 210. Projecting ledge 212 extends from inner face 214. It will be appreciated that bottom rail 192 may be extruded in a single piece. As mentioned, bottom rail 192 may be made from aluminum, but may also be made from any other suitable material such as steel, or high strength rigid plastic.

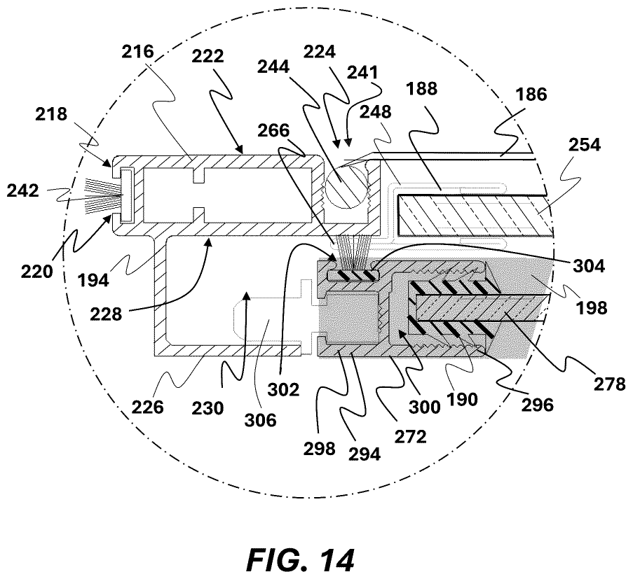

Side rails 194, 196, may also be made from thin lightweight metal such as aluminum. A cross-section of side rail 194 (side rail 196 is the mirror image) is depicted in FIG. 14 (the outline of top rail 198 is depicted in gray over a cross-section of lower window panel 190), and generally includes body 216, presenting side surface 218, in which slot 220 is defined. As depicted in FIG. 14, slot 220 is T-shaped in cross-section and extends along the entire length L₁ of side rail 194. Outer face 222 defines outwardly facing recess 224. Projecting member 226 extends from inner face 228, defining track 230. It will be appreciated that side rails 194, 196, may be extruded in a single piece. As mentioned, side rails 194, 196, may be extruded in a single piece from aluminum, but may also be made from any other suitable material such as fiberglass, steel, or high strength rigid plastic.

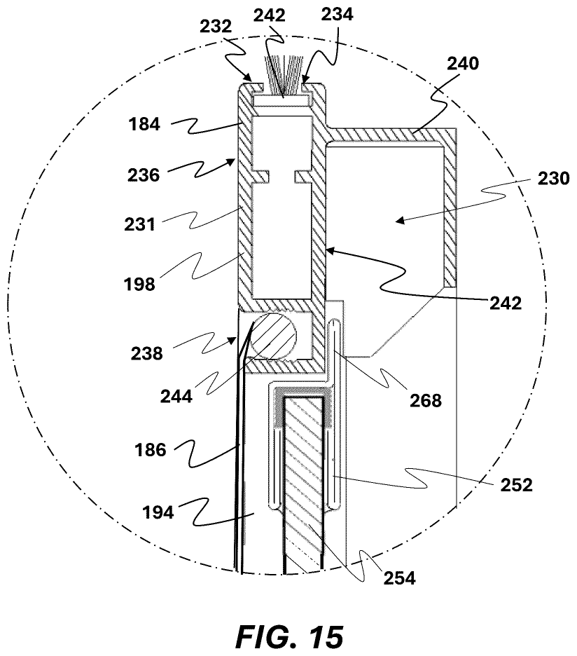

Top rail 198 is depicted in cross section in FIG. 15, and generally includes body 231, presenting top surface 232, in which slot 234 is defined. As depicted in FIG. 15, slot 234 is T-shaped in cross-section and extends along the entire length of top rail 198, which is the identical length as bottom rail 192. Outer face 236 defines outwardly facing recess 238. Projecting member 240 extends from inner face 242, defining the upper end of track 230. Again, body 231 may be extruded in a single piece from aluminum, but may also be made from any other suitable material such as fiberglass, steel, or high strength rigid plastic.

Bottom rail 192, opposing side rails 194, 196, and top rail 198 may be joined together with outer faces 208, 222, and 236 facing the same direction to form frame 184. Recesses 210, 224, and 238 register with each other so as to define groove 241 surrounding opening 200 as depicted in FIG. 2. Track 230 extends around opening 200 on the interior side as depicted in FIG. 3.

As depicted, slots 206, 218, 234, may receive weatherstripping 242 having a T-shaped cross-section conforming to the T-shaped cross-section of the slots. Alternatively, slots 206, 218, 234, may receive other components useful to adapt frame 184 to fit with existing window screen mounts as previously described in reference to FIG. 10.

Screen 186 may made from commonly available window insect screen material such as fiberglass, aluminum, or plastic. Spline 244 is received in groove 241 as depicted in FIGS. 13, 14, and 15 to secure screen 186 in place so that screen 186 is stretched to cover entire opening 200.

Upper window panel 188 generally includes bottom rail 246, opposing side rails 248, 250, and top rail 252, receiving glass panel 254. Without limitation, glass panel 254 may be single thickness glass, laminated glass, thin-insulated glass, safety glass, vacuum-sealed insulated glass, all with or without a low-e or other coating, solar photovoltaic glass or panel, or any other type of thin transparent, translucent, or opaque material.

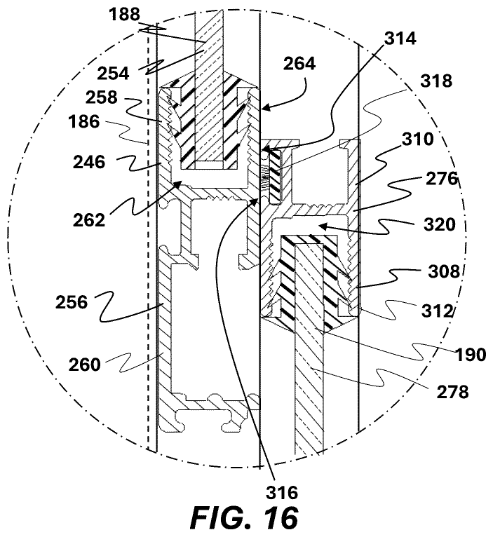

Bottom rail 246 is depicted in cross-section in FIG. 16, and generally includes integral body 256 having upper portion 258 and lower portion 260. Upper portion 258 defines upwardly facing recess 262, which receives glass panel 254. Body 256 presents inner face 264. Body 256 can be extruded from aluminum, or otherwise formed from other suitable metal, fiberglass, or high strength rigid plastic.

Side rail 248 is depicted in cross-section in FIG. 14 (side rail 250 is a mirror image), and has projecting flange 266. Flanges 266 abut inner faces 228 of side rails 194, 196, of frame 184 on each side of upper window panel 188.

Top rail 252 is depicted in cross-section in FIG. 15, and has projecting flange 268. Flange 268 abuts inner face 242 of top rail 198 of frame 184.

Lower window panel 190 generally includes bottom rail 270, opposing side rails 272, 274, and top rail 276, receiving glass panel 278. Again, glass panel 278 may be single thickness glass, laminated glass, thin-insulated glass, safety glass, vacuum-sealed insulated glass, all with or without a low-e or other coating, solar photovoltaic glass or panel, or any other type of thin transparent, translucent, or opaque material.

Bottom rail 270 is depicted in cross-section in FIG. 13, and generally includes integral body 280 having upper portion 282 and lower portion 284. Upper portion 282 defines upwardly facing recess 286, which receives glass panel 278. Body 280 presents outer face 288, which defines slot 290. Slot 290 is T-shaped in cross-section, extends along the entire length of bottom rail 270 and receives weatherstripping 292. Body 280 can be extruded from aluminum, or otherwise formed from other suitable metal, fiberglass, or high strength rigid plastic.

Side rail 272 is depicted in cross-section in FIG. 14 (side rail 274 is a mirror image), and has body 294 with outer portion 296 and inner portion 298. Outer portion 296 defines recess 300, which receives glass panel 278. Inner portion 298 defines slot 302, which is T-shaped in cross-section and receives weatherstripping 304. Inner portion 298 also carries guide 306, which is received in track 230.

Top rail 276 is depicted in cross-section in FIG. 16, and generally includes integral body 308 having upper portion 310 and lower portion 312. Upper portion 310 presents inner face 314, which defines slot 316. Slot 316 is T-shaped in cross-section and receives weatherstripping 318. Lower portion 312 defines downwardly facing recess 320, which receives glass panel 278. Body 308 can be extruded from aluminum, or otherwise formed from other suitable metal, fiberglass, or high strength rigid plastic.

Lower window panel 190 is slidably received in track 230 of frame 184, with guides 306 extending into track 230. Lower window panel 190 can be disposed in a lowered position as depicted in FIG. 3, in which lower portion 284 of bottom rail 270 rests on projecting ledge 212 of bottom rail 192 of frame 184 as depicted in FIG. 13, and top rail 276 of lower window panel 190 is registered with and abutting bottom rail 246 of upper window panel 188, thereby fully closing lower portion L of opening 200. Bottom rail 270 may have sliding latches 170 which can selectively withdraw pins 172 (which may be spring-loaded), which engage with holes (not depicted) in frame 184. Lower window panel 190 can be slid upward in track 230 from the lowered position depicted, to a fully raised “self storing” position in which lower window panel 190 is positioned in upper portion U of opening 200 parallel with upper window panel 188. Sliding latches 170 can be used to extend pins 172 to engage holes (not depicted) in track 230 to hold lower window panel 190 in this position when it is desired to fully open lower portion L of opening 200 for ventilation. It will be appreciated that additional holes (not depicted) may be provided in track 230 to enable lower window panel 190 to be positioned at one or more intermediate points between the lowered position and the fully raised position and held in place with pins 172.

Moreover, lower window panel 190 may be removed from track 230 by fully retracting pins 172 and slightly tilting and pivoting lower window panel 190 to enable lifting lower window panel 190 out of frame 184. In addition, if it is desired to use the entire opening 200 for ventilation, upper window panel 188 can also be removed from frame 184 using sliding latches 322 to retract pins 324, which engage in holes (not depicted) in frame 184. The lower edge of upper window panel 188 can then be tilted inward. Once tilted, upper window panel 188 can be pivoted and likewise be lifted out of frame 184.

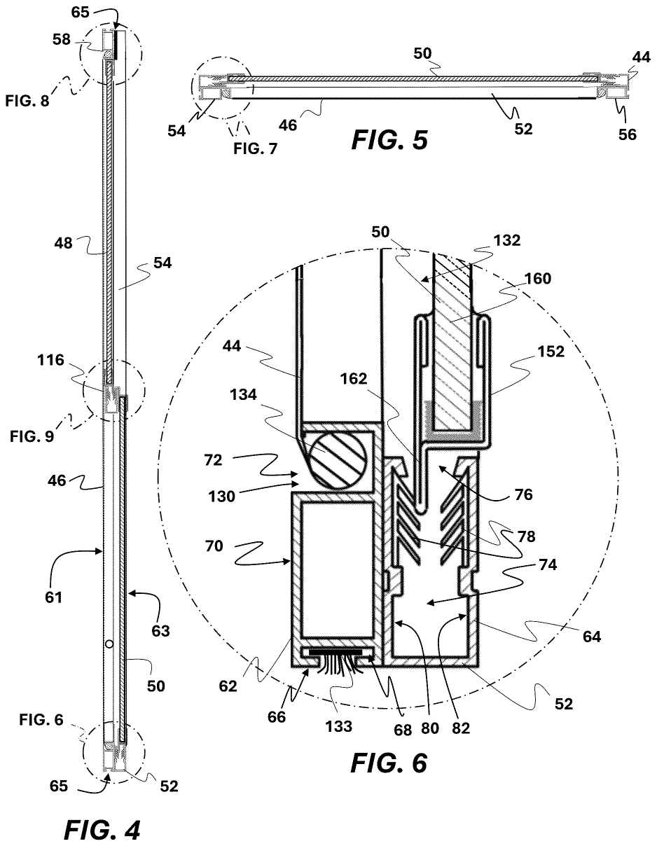

As with the embodiment of FIGS. 4-9, frame 184 has projecting pins 174, 176, 178, 180, to enable combination window screen and storm window 20 to be secured to the exterior side of a window 22. Pins 174, 176, may be fixed, while pins 178, 180, are axially slidable so that a user can extend and retract them as desired. Pins 174, 176, 178, 180, can engage in pre-drilled holes 182 in window frame 24 to secure combination window screen and storm window 20 in place. During installation, pins 174, 176, can be first advanced into pre-drilled holes (not depicted) in header 30, then pins 178, 180, can be retracted while the bottom edge of combination window screen and storm window 20 is swung in toward window 22. Once combination window screen and storm window 20 is properly positioned, pins 178, 180, can be extended into pre-drilled holes 182 to secure combination window screen and storm window 20 in place. Removal can be accomplished by reversing this procedure.

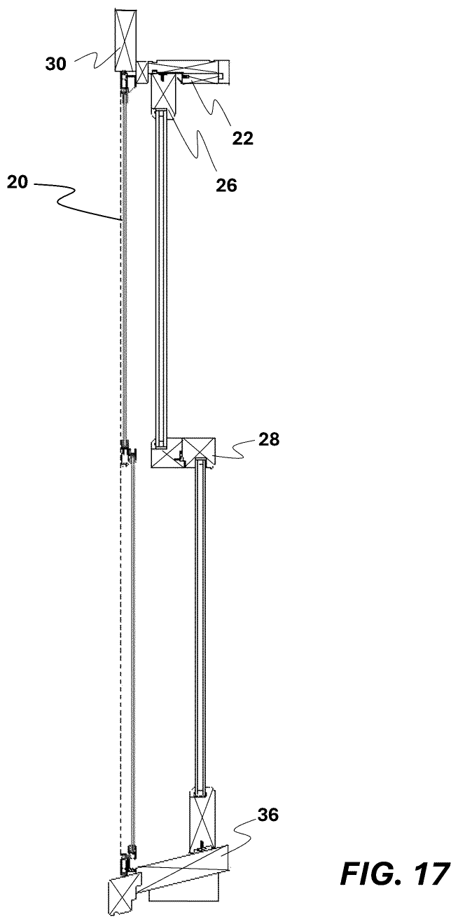

FIG. 17 is a cross-sectional view depicting combination window screen and storm window 20 installed on a double-hung window 22.

Additional features and embodiments of the inventions are depicted in FIGS. 10, 18A, 18B, and 19. As depicted in FIG. 10, it is generally desirable for the thickness dimension T₁ of combination window screen and storm window 20 to be a standard dimension. The inventors have found that a T₁ dimension of ¾ inch is preferable, although other T₁ dimensions could be adopted as well. In applications having existing window screen mounts 328, however, these will sometimes have a narrower dimension T₂. For example, existing window screens will often have a T₂ dimension of 7/16 inch. An adapter 330 can be provided for such situations. Adapter 330 generally includes body 332 with T-slot engaging projection 334, and defining slot 336 with a T-shaped cross section. T-slot engaging projection 334 is adapted to slide into slots 68, 90, 112, 206, 220, or 234 in frames 44, 184, to enable installation in an existing screen mount 328. Slot 336 can receive weatherstripping with a conforming T-shaped cross-section as described above.

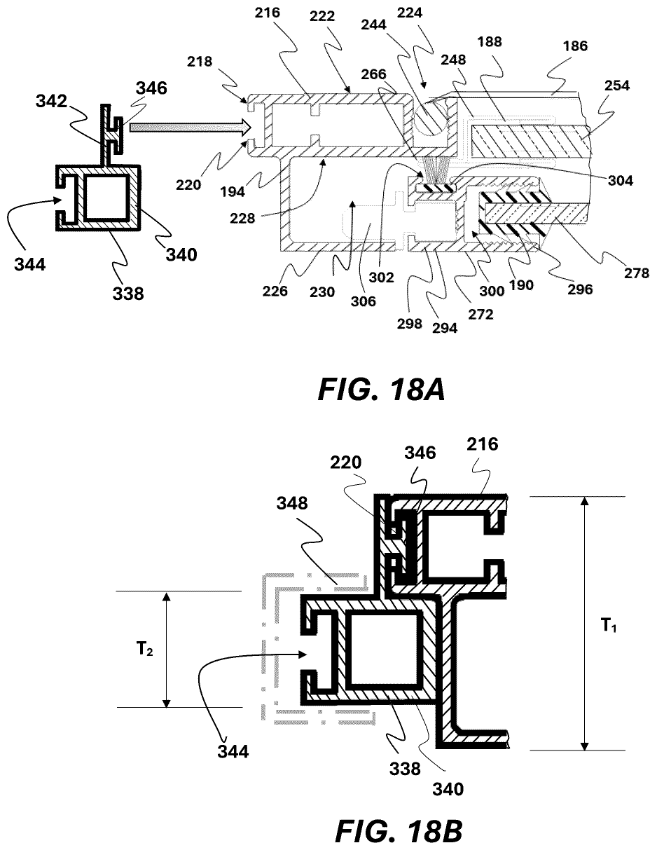

FIGS. 18A and 18B depict another adapter embodiment for the combination window screen and storm window 20 embodiment depicted in FIGS. 11-16. Adapter 338 generally includes body 340 with projecting arm 342. Body 340 defines slot 344 with a T-shaped cross section. Arm 342 has T-slot engaging projection 346 adapted to slide into slots 206, 220, or 234 in frame 184, to enable installation in an existing screen mount 348 having a thickness dimension T₂ of, for example, 7/16 or 5/16 inch. Slot 344 can receive weatherstripping with a conforming T-shaped cross-section as described above.

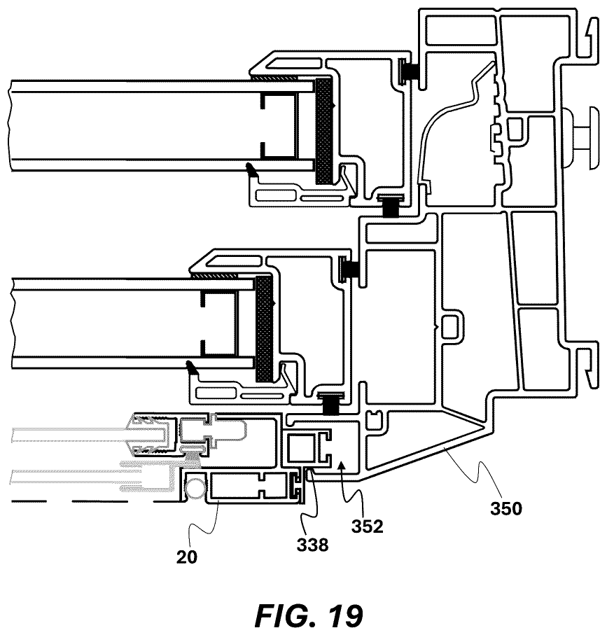

While the description above has generally focused on wood windows, adapter 338 can also enable combination window screen and storm window 20 to be used with vinyl or clad windows. For example, FIG. 19 depicts a cross-section of a vinyl window having jamb profile 350 with recess 352 for receiving a screen. As depicted, adapter 338 can fit into recess 352 to enable combination window screen and storm window 20 to be installed without further modification.

Other implementations of the design may include additional components or features, including, but not limited to: laminated glass in place of standard glass in the panels 48, 50, 188, 190, for sound protection from, for example, noise that results from block traffic, airports, city, and the like; solar photovoltaic glass in place of standard glass in the panels 48, 50, 188, 190, to convert sunlight into electrical energy that may be used to contribute to the power supply of the building; use as a stand-alone window for three season rooms (like cabins or sheds); clips, latches, springs with lift levers in place of pins 174, 176, 178, 180; a second track to enable the upper panel to slide; providing the optional center rail 116 with two grooves so that separate screens could cover the upper portion U and the lower portion L of opening 60, 200, separately; a sliding bottom screen section to enable interior installation; configuring the device to install on the interior of casement and awning hinged windows in addition to double-hung windows as described above; frame 44, 184, being made from materials that are translucent to minimize view obstruction; or providing a nailing strip or fin around the perimeter in place of weatherstripping to enable the window covering to install directly to a wall (without a window frame).

Considering the foregoing, the improvements herein provide a combination window screen and storm window that is suitable for use throughout the year. This combination window screen and storm window may include upper and lower removable glass panels, which install on an interior side of the window. The glass panels improve energy efficiency, provide protection from weather, provide improved occupant comfort, and reduce sound transmission through the window. The combination window screen and storm window includes a frame that enables the lower removable glass panel to translate (or slide) up-and-down and lock in different positions to provide variable ventilation. Its highest position may enable the lower removeable glass panel to completely reside behind the upper removeable glass panel to provide a warm season, “self-storing” ventilation function. If desired, both the lower removeable glass panel and the upper removeable glass panel can remove from the assembly. An active hardware and weather-strip system enables building owners to easily install or remove the combination window screen and storm window, similar to conventional window screens. The three main component design of a frame with mesh screen, upper window panel, and lower window panel, is an improvement over a typical aluminum framed combination covering using four main components: an open frame; a top glass panel with aluminum surrounds; a bottom glass panel with aluminum surrounds and a mesh screen with aluminum surround (making three inserts added to a frame). The three component design reduces manufacturing labor, material usage, and shipping costs due to its lighter weight and reduced overall thickness. It also improves the visual appearance of the unit and supports a slimmer, more refined assembly profile.

Various embodiments of systems, devices, apparatuses, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of 35 U.S.C. § 112(f) are not to be invoked unless the specific terms “means for” or “step for” are recited in the subject claim.

What is claimed is:

1. A combination window screen and storm window comprising:
a frame having a top rail, a bottom rail, and a pair of opposing side rails defining an opening, the frame having an exterior side presenting an exterior face and an interior side presenting an interior face, the frame defining a track in the opening adjacent the interior face, a mesh screen being disposed on the exterior side of the frame;
an upper window panel disposed in an upper portion of the opening between the exterior side of the frame and the interior side of the frame;
a lower window panel disposed in the track and slidably shiftable in the track between a lowered position in which the lower window panel is disposed in a lower portion of the opening, and a raised position in which the lower window panel is disposed in the upper portion of the opening adjacent the upper window panel; and
wherein the frame is adapted to mount on the exterior side of a window with the interior side of the frame facing the window.

2. The combination window screen and storm window of claim 1, wherein the exterior face of the frame defines a groove extending around the opening, and the screen presents an outer periphery, and wherein a spline is received in the groove to attach the screen to the frame.

3. The combination window screen and storm window of claim 1, wherein the lower window panel further comprises a sliding latch selectively operable to latch the lower window panel in the lowered position or the raised position.

4. The combination window screen and storm window of claim 3, wherein the sliding latch is selectively operable to latch the lower window panel in at least one intermediate position between the lowered position and the raised position.

5. The combination window screen and storm window of claim 1, wherein the lower window panel is selectively removable from the frame.

6. The combination window screen and storm window of claim 1, wherein the upper window panel is selectively removable from the frame.

7. The combination window screen and storm window of claim 1, wherein the top rail, bottom rail, and opposing side rails of the frame are hollow.

8. The combination window screen and storm window of claim 1, wherein the top rail, bottom rail, and opposing side rails of the frame are made from aluminum, fiberglass, steel, or high strength rigid plastic.

9. The combination window screen and storm window of claim 1, wherein the top rail, bottom rail, and opposing side rails of the frame each have an outwardly facing edge surface, the outwardly facing edge surface defining a slot with a T-shaped cross-section.

10. The combination window screen and storm window of claim 9, further comprising a plurality of weatherstripping members each having a T-shaped cross-section, each one of the plurality of weatherstripping members received in a separate one of the slots.

11. The combination window screen and storm window of claim 9, wherein the frame defines a thickness dimension extending between the exterior face and the interior face, the combination window screen and storm window further comprising an adapter having a T-slot engaging projection adapted to be received in the slot, the adapter presenting a thickness dimension less than the thickness dimension of the frame.

12. An auxiliary window system adapted to mount on an exterior side of a window in a structure, the system comprising:
a hollow metal frame having a top rail, a bottom rail, and a pair of opposing side rails framing an opening, the frame presenting an exterior side, an interior side, and an outwardly facing edge surface, a mesh screen covering the opening on the exterior side; and
a first window panel having a transparent portion and being disposed in the opening in the frame between the interior side and the exterior side, the window panel being selectively shiftable between a lowered position in which the window panel closes the opening to block air from passing through the mesh screen and a raised position in which the window panel is shifted to enable air passage through a portion of the mesh screen.

13. The auxiliary window system of claim 12, wherein the first window panel is selectively removable from the frame.

14. The auxiliary window system of claim 12, wherein the first window panel has a latch enabling the first window panel to be positioned at an intermediate position between the lowered position and the raised position, the intermediate position enabling air passage through a portion of the mesh screen.

15. The auxiliary window system of claim 12, further comprising a second window panel having a transparent portion and being disposed in the opening in the frame between the interior side and the exterior side, wherein the first window panel is disposed in a first plane inside the opening and the second window panel is disposed in a second plane parallel with the first plane.

16. The auxiliary window system of claim 15, wherein the second window panel is fixed in position in an upper portion of the opening, and the first window panel is disposed in a lower portion of the opening when the first window panel is in the lowered position.

17. The auxiliary window system of claim 12, wherein the mesh screen presents an outer periphery, and the system further comprises a spline, the frame having an outer face defining a groove on the exterior side, the spline being received in the groove to attach the screen to the frame.

18. The auxiliary window system of claim 12, wherein the outwardly facing edge surface defines a slot having a T-shaped cross-section.

19. The auxiliary window system of claim 18, further comprising a plurality of weatherstripping members, the weatherstripping members having a T-shaped cross-section conforming to the T-shape of the slot, the weatherstripping members being received in the slot.

20. The auxiliary window system of claim 18, wherein the frame defines a thickness dimension extending between the exterior face and the interior face, the system further comprising an adapter having a T-slot engaging projection adapted to be received in the slot, the adapter presenting a thickness dimension less than the thickness dimension of the frame.

21. The auxiliary window system of claim 12, wherein the frame defines a thickness dimension extending between the exterior face and the interior face, the thickness dimension being within a range from ½ inch to ¾ inch inclusive.

22. The auxiliary window system of claim 21, wherein the thickness dimension is ¾ inch.

23. The auxiliary window system of claim 12, wherein the frame defines a track, the first window panel being slidable in the track.

24. A method of improving the energy efficiency of a window in a structure while enabling natural ventilation of the structure through the window, the method comprising:
providing a combination window screen and storm window comprising:
a frame comprising a top rail, a bottom rail, and pair of opposing side rails framing an opening, the frame presenting an exterior side, an interior side, and a outwardly facing edge surface, the top rail, the bottom rail, and each one of the pair of opposing side rails being a hollow metal section, a mesh screen covering the opening on the exterior side; and
a first window panel having a transparent portion in the opening in the frame between the interior side and the exterior side, the window panel being selectively shiftable between a lowered position in which the window panel closes the opening to block air from passing through the mesh screen and a raised position in which the window panel is shifted to enable air passage through a portion of the mesh screen; and
affixing the combination window screen and storm window on an exterior side of the window.

25. An auxiliary window system adapted to mount on an exterior side of a window in a structure, the system comprising:
a frame assembly presenting an exterior side, an interior side, and an outwardly facing edge surface, the frame assembly having a hollow top rail, a hollow bottom rail, and a pair of opposing hollow side rails together framing an opening, and a mesh screen entirely covering the opening;
an upper window panel having a transparent portion, the upper window panel disposed in an upper portion of the opening between the interior side and exterior side of the frame assembly; and
a lower window panel having a transparent portion, the lower window panel disposed in the opening in the frame between the interior side and the exterior side, the window panel being selectively shiftable between a lowered position in which the window panel closes a lower portion of the opening to block air from passing through the mesh screen and a raised position in which the lower window panel is shifted to enable air passage through the mesh screen.
